(19) United States
(12) Patent Application Publication
(10) Pub. No.: US 2004/0070670 A1
(43) Pub. Date: Apr. 15, 2004

(54) Wireless digital camera image caching apparatus and method

(76) Inventor: Ward S. Foster, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/269,759

(22) Filed: Oct. 11, 2002

(51) Int. Cl. H04N 5/225; H04Q 7/24; H04B 7/26

(52) U.S. Cl. 348/207.1; 455/41.3; 370/338

(57) ABSTRACT

This invention relates to a digital camera with a wireless networking hardware that automatically transmits images from its internal storage to a service on the Internet. Whenever the camera is in range of a wireless network, the camera transmits all of its images on the camera to the Internet service. It then marks all of the transferred images as having been transferred and may delete them from the camera as it needs to make more space for newer images. This allows the user to use the camera as if it had limitless imaging capacity

### BACKGROUND OF THE INVENTION

1. Field of the Invention

This invention relates to a digital camera with a wireless networking hardware that automatically transmits images from its internal storage to a service on the Internet.

2. Description of the Related Art

Prior to the present invention, as set forth in general terms above and more specifically below, it is known, in the imaging art, to filter video. Exemplary of such prior art is U.S. patent application Publication No. 2001/0035976 ('976) to A. Poon, entitled “Method and System for Online Presentations of Writings and Line Drawings.” The '976 reference is concerned with filtering video in order to obtain the writings and/or drawings from a presentation and transmitting then online so that writings and/or drawings can be viewed separately from the presentation. While the '976 reference is capable of filtering video, it is not at all concerned with caching of the digital images to make a digital camera appear as though it had virtually limitless memory or to simply store the digital images in a service separate from the camera. Consequently, a more advantageous system, then, would be provided if the digital images could be stored in a separate service to provide the digital camera with virtually limitless memory.

It is also known, in the digital imaging art, to employ a viewing device that is separate from the digital camera. Exemplary of such prior art is U.S. patent application Publication No. 2001/0040695 ('695) to N. Manowitz, entitled “Method and Apparatus for Improved Digital Image Control.” The '695 reference is concerned with an image viewing device that is separate from the digital camera. This involves removing the physical memory from the digital camera and inserting it into the viewing device. While the '695 reference discloses a device that is capable of uploading and downloading images from another remote device, such as a computer, the reference does not address using the digital camera itself as the device doing the uploading and downloading of the images. Also, this reference is not concerned with the caching of the digital images to a remote device for ease-of-use and for virtual limitless memory. Therefore, a further advantageous system, then, would be provided if the digital camera itself could perform the uploading and downloading of the images to a remote device for ease-of-use and for virtual limitless memory.

It is apparent from the above that there exists a need in the art for a digital camera that is capable of uploading and downloading images to a remote service separate from the digital camera in order to provide a virtual limitless memory for the digital camera. It is a purpose of this invention to fulfill this and other needs in the art in a manner more apparent to the skilled artisan once given the following disclosure.

### SUMMARY OF THE INVENTION

Generally speaking, this invention fulfills these needs by providing an apparatus for digital camera image caching, comprising: a digital camera including a wireless networking hardware; and a wireless network operatively connected to the camera such that the camera can wirelessly upload/download images from the camera to a remote device operatively connected to the wireless network.

In certain preferred embodiments, the wireless networking hardware can be any suitable wireless communication system that employs a wireless communication protocol, such as Blue tooth, 802.11b or the like. Also, the wireless network can be, but is not limited to, the Internet, an intranet or the like. Finally, the remote device can be, but is not limited to, a server operatively connected to the wireless network.

In another further preferred embodiment, the digital camera of the present invention employs an apparatus and method that allows the digital camera to cache the images on to a remote device for later retrieval. This provides the digital camera with a virtual limitless memory.

The preferred digital camera, according to this invention, offers the following advantages: ease of uploading/downloading images; virtual limitless image memory; ease-of-use; durability; and excellent economy. In fact, in many of the preferred embodiments, these factors of ease of uploading/downloading images, virtual limitless image memory, and ease-of-use are optimized to an extent that is considerably higher than heretofore achieved in prior, known digital cameras.

The above and other features of the present invention, which will become more apparent as the description proceeds, are best understood by considering the following detailed description in conjunction with the accompanying drawings, wherein like characters represent like parts throughout the several views and in which:

### BRIEF DESCRIPTION OF THE DRAWINGS

FIG. 1 is a schematic illustration of an apparatus for wireless digital camera image caching, according to one embodiment of the present invention; and

FIG. 2 is a flowchart of a method for wireless digital camera image caching, according to one embodiment of the present invention.

### DETAILED DESCRIPTION OF THE INVENTION

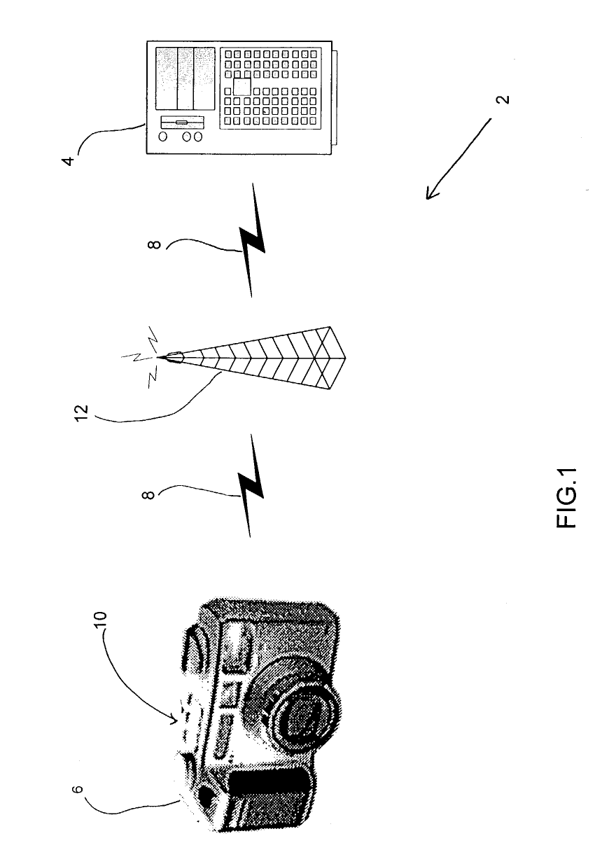

With reference first to FIG. 1, there is illustrated one preferred embodiment for use of the concepts of this invention. FIG. 1 is a schematic illustration of an apparatus 2 for wireless digital camera image caching. Apparatus 2 includes, in part, remote wireless device 4, digital camera 6, conventional wireless link 8, graphical user interface (GUI) 10, and access point 12.

Although the various embodiments of the invention disclosed herein will be described with reference to apparatus 2 shown schematically in FIG. 1, the invention is not limited to use with apparatus 2. The invention may be implemented in or used with any computer system in which it is necessary or desirable to access electronic data.

Remote wireless device 4 can be any suitable device that is capable of receiving and storing images from digital camera 6. Remote wireless device 4 can be a computer connected to an Internet/intranet network that is also connected to wireless access point 12. Also, remote wireless device 4 can be a remote Web server operatively connected to conventional wireless link 8. The Web server can host a Web site for a Web service. The Web site, preferably, would interact with graphical user interface 10 on digital camera 6. The Web service, preferably, would interact with graphical user interface 10 on digital camera 6.

Link 8 interconnects remote wireless device 4 and digital camera 6 and represents generally a cable, wireless, or remote connection via a telecommunication link, an infrared link, a radio frequency link, or any other connector or system that provides electronic communication between remote wireless device 4 and digital camera 6. Link 8 may represent an intranet, an Internet, or combination of both.

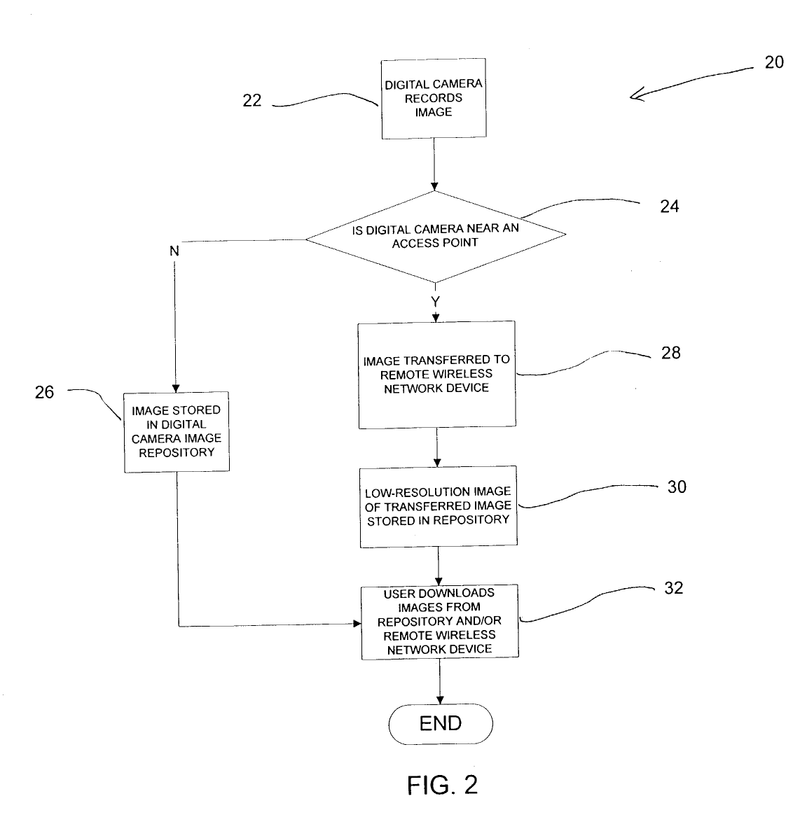

FIG. 2 illustrates method 20 for wireless digital camera image caching. Method 20 includes, in part, the steps of; having the digital camera record the image and store the image in the digital camera image repository (step 22), determining when the digital camera image repository is accessible to an access point (step 24), storing the image in the digital camera image repository (step 26), wirelessly transferring the stored image in the image repository to a remote wireless network device (step 28), storing a low-resolution image of the transferred image in the digital camera image repository (step 30), and downloading images from the digital camera repository and/or the remote wireless network device (step 32).

With respect to step 22, the user conventionally records images using the digital camera and the images are conventionally stored in the digital camera image repository. With respect to step 24, the digital camera image repository is monitored. Once an image has been stored in the repository, the image can be transferred to remote wireless device 4 if the camera is accessible to access point 12 (step 28). Preferably, digital camera 6 is constantly monitoring/pinging for access point 12. It is to be understood that the term “pinging” refers to a method of determining whether or not a specific Internet protocol (IP) address is accessible. When an access point 12 has been located by digital camera 6, digital camera 6 will begin transferring stored images to access point 12. After the image has been transferred to remote wireless device 4, the image is marked in the digital camera image repository as having been saved. Also, in order to free up memory on digital camera 6, images (or the corresponding low-resolution images) that have been marked as “saved” may be deleted from the camera's repository to free up memory for new images. This could be done either manually or automatically. Finally, in order to minimize memory usage on digital camera 6, a low-resolution image of the saved image can be stored on the digital camera image repository (step 30).

If the user does not have access to access point 12, the images are stored in the digital camera image repository (step 26). It is to be understood that an alert mechanism located in the digital camera can be utilized to warn the user that the digital camera image repository is full. Also, it is to be understood that a gauge or other similar monitoring device can be utilized on the digital camera in order to inform the user as to the amount of storage available in the digital camera image repository. Finally, it is to be understood that the images previously stored in the repository can be wirelessly transferred to the remote wireless network device without informing the user of the transfer.

With respect to step 28, as discussed above, the images stored in the digital camera image repository are wirelessly transferred to a remote wireless network device. It is to be understood that any suitable wireless transmission protocol, such as Blue tooth, 802.11b or the like can be utilized to transfer the images to the remote wireless network device. As discussed above, the image can be transferred to the remote wireless network device without informing the user of the transfer. However, it is also to be understood that the user can manually, wirelessly forward the image to the remote wireless network device.

With respect to step 32, the user can manipulate graphical user interface (GUI) 10 located on the back of digital camera 6. In this manner, the user can manipulate graphical user interface 10 in order to, for example, scroll through the images located on remote network device 4 or the image repository of digital camera 6. From there, the user can select images to be stored, for example, on the user's personal computer (PC). Also, the user can select images to be printed. Also, the user can select images to be transferred to another different remote wireless network device. Finally, the user can select images to be deleted.

With respect to step 32, it is to be understood that when the user wants to view or make other uses of the images, the user can go to the remote wireless network device (by using a web browser or any other kind of networking mechanism on a desktop computer, portable computer or personal digital assistant (PDA)) to retrieve the images.

It is to be understood that the flowchart of the FIGURE shows the architecture, functionality, and operation of one implementation of the present invention. If embodied in software, each block may represent a module, segment, or portion of code that comprises one or more executable instructions to implement the specified logical function(s). If embodied in hardware, each block may represent a circuit or a number of interconnected circuits to implement the specified logical function(s).

Also, the present invention can be embodied in any computer-readable medium for use by or in connection with an instruction execution system such as a computer/processor based system or other system that can fetch or obtain the logic from the computer-readable medium and execute instructions contained therein. A “computer-readable medium” can be any medium that contains, stores, or maintains programming for use by or in connection with the instruction execution system. The computer-readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as floppy diskettes or hard drives, a random access memory (RAM), a read-only memory (ROM), an erasable programmable read-only memory, or a portable compact disc.

Although the flowchart of the FIGURE shows a specific order of execution, the order of execution may differ from that which is depicted. For example, the order of execution of two or more blocks may be scrambled relative to the order shown. Also, two or more blocks shown in succession in the FIGURE may be executed concurrently or with partial concurrence. All such variations are within the scope of the present invention.

Once given the above disclosure, many other features, modifications or improvements will become apparent to the skilled artisan. Such features, modifications or improvements are, therefore, considered to be a part of this invention, the scope of which is to be determined by the following claims.

What is claimed is:

1. An apparatus for digital camera image caching, comprising:
a digital camera including a wireless networking hardware; and
a wireless network operatively connected to said camera such that said camera can wirelessly upload/download images from said camera to a remote device operatively connected to said wireless network.

2. The apparatus, as in claim 1, wherein said digital camera is further comprised of:
a graphical user interface operatively connected to said wireless networking hardware.

3. The apparatus, as in claim 1, wherein said remote device is further comprised of:
an access point; and
a server operatively connected to said access point.

4. The apparatus, as in claim 1, wherein said wireless network is further comprised of:
a link.

5. The apparatus, as in claim 1, wherein said wireless network is further comprised of:
the Internet.

6. A method for wireless digital camera image caching, comprising the steps of:
recording a first image by a digital camera;
storing said first image in an image repository;
determining when said camera is accessible to an access point;
wirelessly transferring said first image in said repository to a remote wireless network device through said access point; and
downloading said first image from said remote wireless network device.

7. The method, as in claim 6, wherein said method is further comprised of the steps of:
recording a second image by said digital camera;
storing said second image in said image repository; and
downloading said second image from said image repository.

8. The method, as in claim 6, wherein said determining step is further comprised of the step of:
employing a monitoring means to determine when said camera is accessible to said access point.

9. The method, as in claim 8, wherein said monitoring means is further comprised of:
a pinging means.

10. The method, as in claim 6, wherein said downloading step is further comprised of the step of:
employing an interface means to manipulate said first image.

11. The method, as in claim 7, wherein said downloading step is further comprised of the step of:
employing an interface means to manipulate said second image.

12. The method, as in claim 10, wherein said interface means is further comprised of:
a graphical user interface.

13. The method, as in claim 11, wherein said interface means is further comprised of:
a graphical user interface.

14. A means for wireless digital camera image caching, comprising:
a digital camera means including hardware means for wireless networking; and
a wireless network means operatively connected to said camera means for wirelessly upload/download images from said camera to a remote device means operatively connected to said wireless network.

15. The apparatus, as in claim 14, wherein said digital camera means is further comprised of:
a graphical user interface means operatively connected to said hardware means.

16. A computer readable medium, having instructions for:
recording a first image by a digital camera;
storing said first image in an image repository;
determining when said camera is accessible to an access point;
wirelessly transferring said first image in said repository to a remote wireless network device through said access point; and
downloading said first image from said remote wireless network device.

17. The method, as in claim 16, wherein said method is further comprised of the steps of:
recording a second image by said digital camera;
storing said second image in said image repository; and
downloading said second image from said image repository.

18. The method, as in claim 16, wherein said determining step is further comprised of the step of:
employing a monitoring means to determine when said camera is accessible to said access point.

19. The method, as in claim 18, wherein said monitoring means is further comprised of:
a pinging means.

20. The method, as in claim 16, wherein said downloading step is further comprised of the step of:
employing an interface means to manipulate said first image.

21. The method, as in claim 17, wherein said downloading step is further comprised of the step of:
employing an interface means to manipulate said second image.

22. The method, as in claim 20, wherein said interface means is further comprised of:
a graphical user interface.

23. The method, as in claim 21, wherein said interface means is further comprised of:
a graphical user interface.

24. In a computer network, a method for enabling a user to:
record a first image by a digital camera;
store said first image in an image repository;
determine when said camera is accessible to an access point;
wirelessly transfer said first image in said repository to a remote wireless network device through said access point; and
download said first image from said remote wireless network device.

25. The method, as in claim 24, wherein said method is further comprised of the steps of:
record a second image by said digital camera;
store said second image in said image repository; and
download said second image from said image repository.

26. The method, as in claim 24, wherein said determine step is further comprised of the step of:
employ a monitoring means to determine when said camera is accessible to said point.

27. The method, as in claim 26, wherein said monitoring means is further comprised of:
a pinging means.

28. The method, as in claim 24, wherein said download step is further comprised of the step of:
employ an interface means to manipulate said first image.

29. The method, as in claim 25, wherein said download step is further comprised of the step of:
employ an interface means to manipulate said second image.

30. The method, as in claim 28, wherein said interface means is further comprised of:
a graphical user interface.

31. The method, as in claim 29, wherein said interface means is further comprised of:
a graphical user interface.
